(19) United States
(12) Patent Application Publication
(10) Pub. No.: US 2005/0207433 A1
(43) Pub. Date: Sep. 22, 2005

(54) Video communication systems and methods

(75) Inventor: Hong Tao Ni, Camberwell (AU)

Correspondence Address: BROWN, RAYSMAN, MILLSTEIN, FELDER & STEINER LLP, 900 THIRD AVENUE, NEW YORK, NY, 10022, US

(73) Assignee: Camelot Technology Associates Ltd.

(21) Appl. No.: 11/143,172

(22) Filed: Jun. 1, 2005

Related U.S. Application Data
(63) Continuation-in-part of application No. 10/755,067, filed on Jan. 9, 2004.
(60) Provisional application No. 60/620,604, filed on Oct. 20, 2004.

(51) Int. Cl. H04L 12/28

(52) U.S. Cl. 370/401

(57) ABSTRACT

Video communications systems and methods video communications between user terminals in networks that are separated by a firewall. A first user terminal establishes a persistent connection with its proxy that is on the other side of a firewall protecting the terminal. Other terminals can conduct video calls or conferences with the first user terminal via the persistent connection. A terminal database server maintains information about each terminal, such as their addresses, and assists with establishing each video call or conference.

### CROSS-REFERENCE TO RELATED APPLICATIONS

This application is a continuation-in-part application of U.S. patent application Ser. No. 10/755,067 filed on Jan. 9, 2004, and titled “Video Conferencing System”, and this application claims the benefit of U.S. Provisional Patent Application No. 60/620,604 filed on Oct. 20, 2004, and titled “VidRev Vid Phone,” both of which are hereby incorporated by reference in their entirety (collectively, “Parent Applications”).

### BACKGROUND OF THE INVENTION

1. Field of the Invention

The present invention relates generally to multimedia communications. More particularly, the present invention relates to methods for video communications between user terminals in networks separated by a firewall.

2. Description of the Related Art

Modern video conferencing systems permit multiple users to communicate with each other over a distributed data communications network. The parent applications describe how a video conferencing system of high quality can be easily obtained using ordinary personal computers with Internet access rather than specialized equipment. In particular, an advantage of the described video conferencing system is that it can be easily and rapidly implemented through the installation of a software application downloaded into the computers via the Internet. Once installed into a group of computers, those computers may easily engage in video conferencing with any other computer that has also installed the software application.

Many computers are located within a network, such as a local area network (LAN) of corporations and other enterprises. There is typically a firewall that separates and protects the network from unwanted intrusions from outside the network through any variety and combination of functions, such as packet inspection, etc. The level of protection may be varied by an administrator of the network to provide a desired balance between the firewall having too low a level of security and being overly restrictive.

FIG. 1 shows an intranet 130 having computers 150 and an intranet server 180 separated by a firewall 120 from a public Internet 140 having computers 160 and a web server 170. In order to increase security, the firewall 120 may limit communications between computers in the Intranet 130 and computers in the Internet 140. For example, the firewall 120 may allow certain types of data packets to pass through while limiting other types of data packets. In addition, the firewall 120 may restrict users of computers 150 from accessing all parts of the Internet 140 and therefore deny users full use of the Internet 140. In another example, it is possible that a video conference cannot be setup across the firewall because the firewall is designed and configured to only work with very specific protocols that are not compatible with the protocols or other techniques used by the video conferencing system. While the limitations and restrictions imposed by a firewall achieve the goal of enhancing security, they may prevent an Intranet user from using a video conferencing system with a user outside the Intranet. Although the firewall configuration and settings may be altered by a network administrator when such a problem occurs, this frustrates the goal of the video conferencing systems of the parent applications to be easily installed and used without assistance.

Therefore, a system and method is needed for easy video conferencing between networks separated by a firewall, while preserving the security offered by the firewall. This problem has conventionally been addressed by utilizing more complicated firewalls that pass data traffic of video conferencing systems. While this may work for video conferencing systems using standardized protocols, such as the International Telecommunications Union's protocols H.323 and H.320, it will not work for improved video conferencing systems such as that in the parent applications that use improved, non-standard, protocols and compression techniques.

### BRIEF SUMMARY

It is an object of the preferred embodiments of the inventions described in this application to provide a real-time video communications system with improved reliability, confidentiality, and connection capability.

It is a further object of the preferred embodiments of the inventions to provide a high quality video communications system that can be easily implemented over the Internet using the Transport Control Protocol (TCP) or Internet Protocol (IP) and can be easily installed as a high-end software system at a widely available user terminal, such as a personal computer.

It is another object of the preferred embodiments of the inventions to provide a method of video communications across a firewall.

It is a further object of the preferred embodiments of the inventions to provide a method of video communications across a firewall using non-standardized protocols.

It is another object of the preferred embodiments of the inventions to provide a method of video communications across a firewall without needing to alter the firewall or provide advanced functions in the firewall.

It is a further object of the preferred embodiments of the inventions to provide a method of video communications across a persistent connection between a user terminal and a proxy server, which are separated by a firewall.

It is another object of the preferred embodiments of the inventions to provide a method of video calling between two user terminals.

It is a further object of the preferred embodiments of the inventions to provide a method of video conferencing between multiple user terminals.

It is a particular feature of the preferred embodiments of the inventions that the problems associated with video communications through a firewall are not solved by the conventional method of adapting, tweaking or otherwise modifying the operating functions and characteristics of the firewall, such as modifying packet inspection parameters, but instead permit video communications to be set up while avoiding certain firewall operations and functions, such as packet inspection.

In one aspect of the inventions, a video communications system allows user terminals in networks separated by a firewall to establish a video call through the firewall. A first user terminal in a first network initiates video communications with a second user terminal in a second network by sending a call setup message, containing the phone number or other address corresponding to the other user terminal, to a terminal database. The terminal database looks up the address of the called user terminal's proxy and sends a response to the first user terminal. The response includes data such as the address of the called user terminal's proxy and the port number used by the called user terminal and its proxy. The first user terminal then communicates with the called user terminal's proxy, which has a persistent connection with the called user terminal. After a communication initiation process is completed, the video communications proceeds between the terminals occurring over the persistent connection between the called user terminal and its proxy without interference from the firewall.

In another aspect of the inventions, a video communication system allows a video conference between multiple terminals located in different networks separated by firewalls. Before the video conference occurs, one terminal sends a list of all participating terminals and a conference start time to a terminal database. The terminal database stores the list of terminals and the start time. Also, the terminal database determines a proxy server that is to be utilized by all the terminals during the video conference. The terminal database and the proxy server are outside of the firewalls of the networks that contain the terminals. At the start time of the video conference, each of the terminals sends its registration information to the terminal database. In response, the terminal database sends the address of the proxy server to each terminal on the list of participating terminals. Next, each of the terminals establishes a persistent connection to the proxy server. The terminals then participate in the video conference via their respective persistent connections with the proxy server. The persistent connections with the proxy server allow for the exchange of audio/video data streams for the video conference between all the terminals without interference from firewalls.

### BRIEF DESCRIPTION OF THE DRAWINGS

The foregoing and a better understanding of the present inventions will become apparent from the following detailed description of example embodiments and the claims when read in connection with the accompanying drawings, all forming a part of the disclosure of these inventions. While the foregoing and following written and illustrated disclosure focuses on example embodiments of the inventions, one should clearly understand that the example embodiments are illustrations and examples only and that the inventions are not limited thereto. In the figures of the accompanying drawings, like references are intended to refer to like or corresponding elements.

FIG. 1 illustrates a video conferencing environment having a firewall separating a network from an external network, such as the Internet.

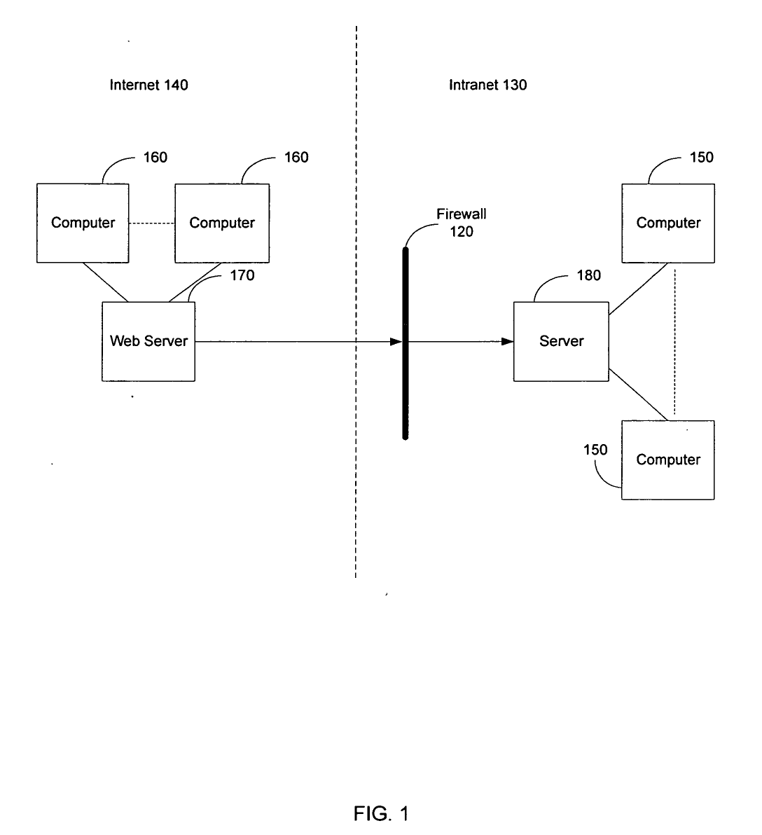

FIG. 2 illustrates a flow diagram of a conventional method of setting up a video conference across a firewall.

FIG. 3 illustrates a flow diagram of a method of setting up a video call according to an exemplary referred embodiment of the invention.

FIG. 4 illustrates a flow diagram of a method of setting up a video call according to another exemplary preferred embodiment of the invention.

FIG. 5 illustrates a flow diagram of a method of setting up a video conference according to another exemplary preferred embodiment of the invention.

FIG. 6 illustrates a multi-queue and multi-channel architecture utilized in another exemplary preferred embodiment of the invention.

### DETAILED DESCRIPTION OF THE PREFERRED EMBODIMENTS

The preferred embodiments of the inventions are described with reference to exemplary video communications systems. However, the inventions are not limited to the preferred embodiments in their implementations. The inventions, or any aspect of the inventions, may be practiced in any video communications system. In addition, the preferred embodiments are shown in block diagram form and are described in this application without excessive detail in order to avoid obscuring the inventions, and in view of the fact that implementations of such systems are known to those of ordinary skill in the art and may be dependent upon circumstances surrounding the implementations. In other words, such specifics are variable but should be well within the purview of one skilled in the art. Where specific details are set forth in order to describe example embodiments of the inventions, it should be apparent to one skilled in the art that the invention can be practiced without, or with variation of, these specific details.

Furthermore, the connections between the user terminals in the preferred embodiments of the inventions are not circuit switched or any other type of fixed connections. They are packet switched network connections over open communication networks. Preferably, the network connections are broadband connections through an Internet Service Provider (ISP) of the user's choice using the Transport Control Protocol (TCP) and Internet Protocol (IP) at the network layer of the International Standards Organization (ISO) network model. As known in the art, various access networks can be connected to the Internet and internal networks may have Internet access via any configuration of firewalls and routers. In addition, data and messages are exchanged between user terminals in manners that are well known to those skilled in the art.

The preferred embodiments of the inventions also include a video communications system such as the systems described in the parent applications, which are designed and optimized to work with broadband connections (i.e., connections providing upload/download speeds of at least 128 kbps) at the user terminals. Again, the video communications system does not require a fixed bandwidth, and may suitably operate at upload/download speeds of 256 kbps or 512 kbps at the user terminals.

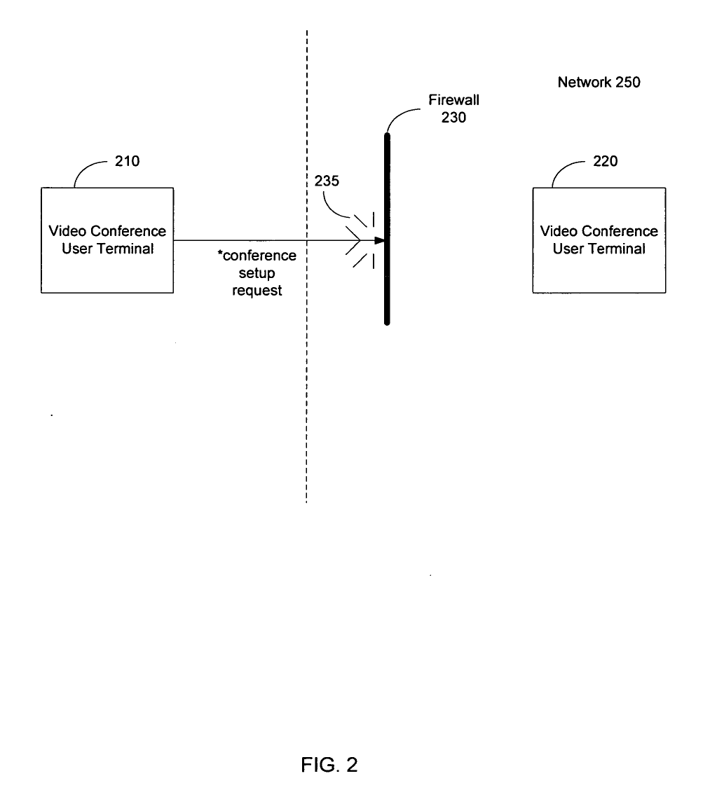

FIG. 2 is a flow diagram illustrating a conventional method of setting up a video conference. Although a limited number of user terminals are shown as being in communication with each other in FIG. 2, this is for illustration purposes only. There may be any number of user's terminals in communication with each other. Indeed, the number of user terminals in communication with one another may vary during a video conference, as the users have the ability to join and drop from a video conference.

A user terminal 210 initiates a video conference by sending a conference setup request message directed to another user terminal 220 in a network 250, such as an Intranet. The conference setup request message includes data such as the IP address of the called user terminal and the port number to be used to deliver the setup request message. The conference setup request message may need to traverse a firewall 230 protecting network 250. As shown in FIG. 2, the conference setup request message may be denied 235 by firewall 230 since, for example, it may be deemed to be potentially harmful to network 250. Alternatively, the firewall might pass the setup request message, but subsequently block the data traffic of the video conference.

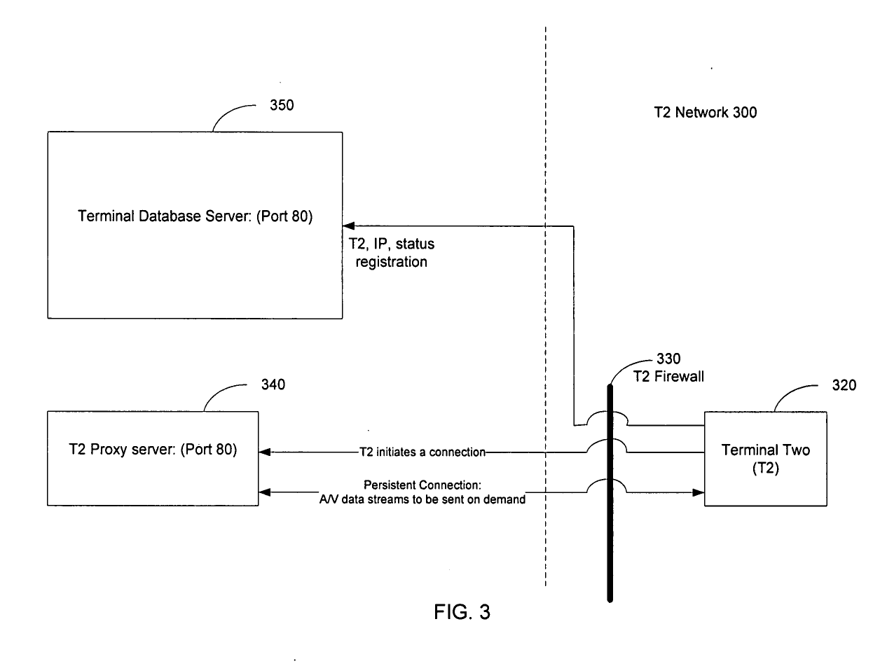

FIGS. 3-6 illustrate the preferred embodiments of the inventions that include systems and methods for video communication between user terminals. In one aspect of the inventions, video communications may be performed as a video call between two user terminals. In another aspect of the inventions, video communications may be performed as a video conference between multiple user terminals.

FIG. 3 is a flow diagram showing a method of setting up a video call according to a preferred embodiment of the inventions. A user terminal, terminal two (T2), 320 is located in T1 network 300 behind T2 firewall 330. T2 proxy server (Port 80) and terminal database server 350 are located outside T2 network 300. Terminal two (T2) 320 registers with and sends messages, such as status updates, to terminal database server 350 through T2 firewall 330. After registering, terminal two (T2) 320 initiates communications with T2 proxy server 340 through T2 firewall 330. Once a connection is established, terminal two (T2) 320 and T2 proxy server 340 maintain a persistent connection that allows data traffic to be exchanged between them on demand. In other words, T2 proxy server 340 serves as a proxy for terminal two (T2) 320 when terminal 320 is called by another terminal and operates as an intermediary in a known manner in passing messages to and from terminal 320. T2 proxy server 340 may also act as a proxy for other terminals in the same fashion.

A persistent connection can be maintained between a terminal and a proxy server in a number of know manners. For example, the terminal and proxy server can pass minimal data (e.g., 1 kb per minute) between the terminal and the proxy at regular time intervals. The exchange of minimal data maintains a port of the proxy server open and prevents a timing out and closing of the port on the proxy server.

Terminal database server 350 maintains information about the video communications system, such as in a database, list or log. The information includes data about the users and the video conferences, including, for example, user identification, terminal identification, billing details, usage information, data security, authentication information, on/offline/in-call status information and IP, port and proxy addresses for respective users and terminals that use the video communications system.

When a first user terminal (not shown) wishes to request a video call with terminal two (T2) 320, the first user terminal sends a video conference request setup message to terminal database server 350. The video conference request setup message contains the address or phone number corresponding to the terminal two (T2) 320. Server 350 looks up the IP address of the T2 proxy server 340 for user terminal 320. Server 350 then returns a response to the initial call setup message including the IP address for the called user terminal and the proxy for the called user terminal. The first user terminal then sends a conference call request setup message to T2 proxy server 340. Since T2 proxy server 340 knows how to communicate with the called terminal two (T2) 320, T2 proxy server 340 forwards to terminal 320 the message sent by the first user terminal.

When the present inventions are used, the filtering conditions and configuration of T2 firewall 330 do not become a hindrance to the setup of video communications. The majority of known firewalls are designed to block only incoming traffic and will not filter an outgoing message. The present inventions leverage that fact when the terminals initiate communications with their proxies by sending outgoing messages to establish the persistent connections. In addition, a common, open port is preferably selected as the port for communications between the terminal and the proxy server to further reduce the chance of blocking the video communications. An example port is port 80, which is used for Hyper Text Transfer Protocol (“HTTP”) messages.

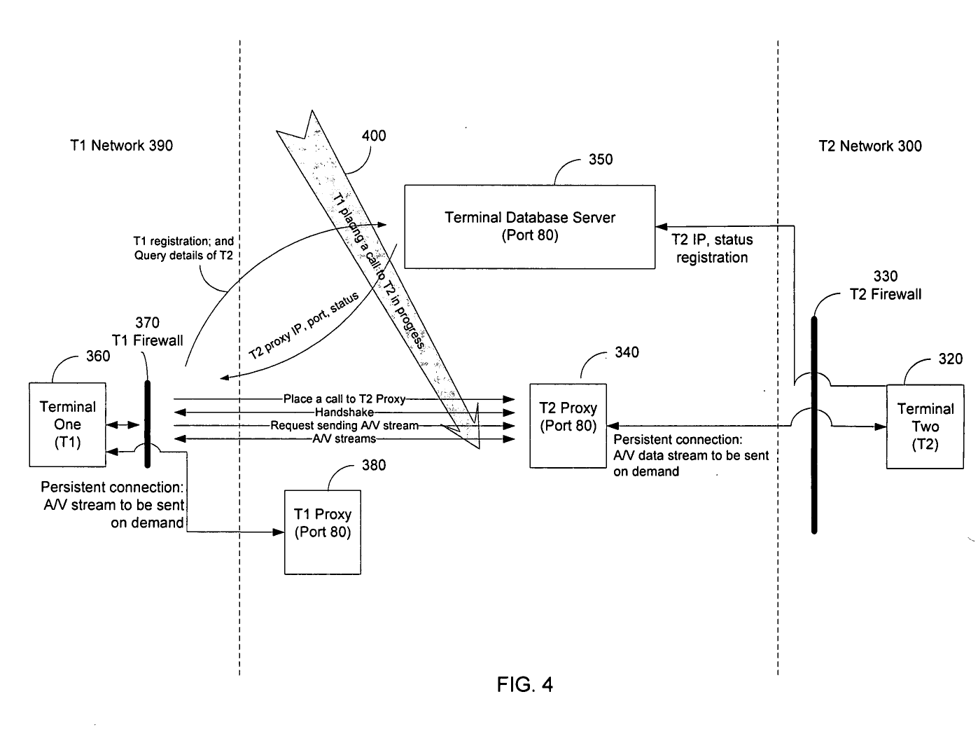

FIG. 4 is a flow diagram graphically illustrating a system and a method involved with setting up a video call according to the preferred embodiments. FIG. 4 depicts a call between two terminals, but the illustrated method can be used with any number of terminals. Arrow 400 indicates the order in which certain events occur when a terminal establishes a video conference call connection with another terminal. A user terminal, terminal one (T1) 360, initiates a video conference call by sending a setup request to terminal database server 350 via T1 firewall 370. The request includes data such as the phone number and query details of the called user terminal, terminal two (T2) 320, as well as registration information corresponding to terminal one (T1) 360. Then, terminal database server 350 sends a message to the terminal one (T1) 360 via T1 firewall 370. The message contains the IP addresses of the called terminal two (T2) 320 and T2 proxy 340 and the on/offline/in call status of terminal two (T2) 320.

Both user terminals 320 and 360 then engage in a handshaking process to begin communications between them on the specified port of T2 proxy 340 without any further involvement by terminal database server 350. The handshaking process stops when the called user terminated (T2) 320 responds with an answer. Thereafter, the video call can proceed between the both user terminal 320 and 360. The video call is maintained via a persistent connection between terminal two (T2) 320 and T2 proxy 340 that is used by terminal one (T1) 360 to communicate with terminal two (T2) 320. While the call placed by terminal one (T1) 360 to terminal two (T2) 320 is in progress, the persistent connection allows audio/video (“a/v”) data streams to be sent, received and fulfilled on demand in a real time manner.

If terminal one (T1) 360 is called by another terminal, terminal one (T1) 360 would communicate with the other terminal via T1 proxy server 380 during a video call. Terminal one (T1) 360 maintains a persistent connection with T1 proxy 380 in the same fashion that terminal two (T2) 320 maintains a connection with its proxy, T2 proxy 340. Both proxy servers 340 and 380 are only used to receive incoming calls and only process a/v data streams during incoming calls. In addition, the proxy servers 340 and 380 can be different or can be the same. One or both of the proxy servers 340 and 380 can also be located in the terminal database server 350.

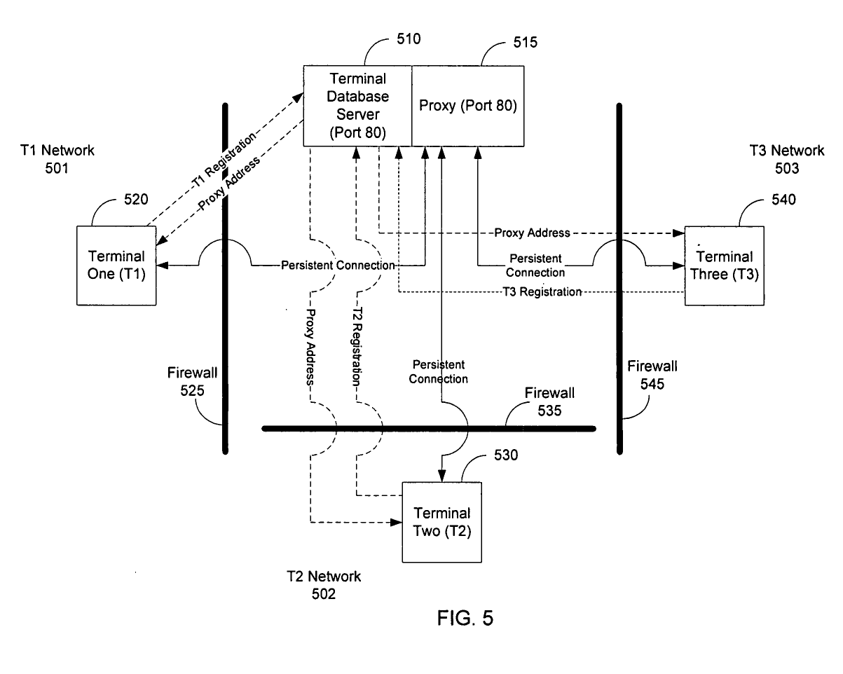

FIG. 5 is a flow diagram showing a system and method of setting up a video conference according to a preferred embodiments of the inventions. In a video conference, multiple terminals are involved in the video communications. While a video conference according to this embodiment can be held between any number of terminals, FIG. 5 only illustrates three terminals as an example of how the video conferencing system and method operates.

Referring to FIG. 5, a video conference is arranged and conducted between terminal one (T1) 520, terminal two (T2) 530, and terminal three (T3) 540. Terminal one (T1) 520 is located in T1 network 501 behind T1 firewall 525. Terminal two (T2) 530 is located in T2 network 502 behind T2 firewall 535. Terminal three (T3) 520 is located in T3 network 503 behind T3 firewall 545. Before the video conference occurs, one terminal sends a list of all participating terminals and a conference start time to the terminal database server 510. For example, terminal one (T1) 520 sends list of terminals including T1 520, T2 530 and T3 540 and a start time to terminal database server 510. The terminal database server 510 stores the list of terminals and the start time. Also, the terminal database server 510 includes a proxy server 51 5 that is to be utilized by all the terminals during the video conference. Terminal database server 510 and proxy server 515 are located outside of the three networks of T1, T2, and T3. While the proxy server 515 is shown in the terminal database server 510, the proxy server 515 can be located outside of terminal database server 510 in another location so that proxy server 515 is a separate system from terminal database server 510.

At the start time of the video conference, each of the terminals sends its registration information (T1 registration, T2 registration, and T3 registration) to the terminal database 510. In response, the terminal database server 510 sends the address of proxy server 515 to each terminal on the list of participating terminals T1 520, T2 530 and T3 540. Next, each of the three terminals, T1 520, T2 530 and T3 540, establishes a persistent connection to the proxy server 515. The terminals T1 520, T2 530 and T3 540 participate in the video conference via their respective persistent connections with proxy server 515. The persistent connections with proxy server 515 allow the exchange of a/v data streams for the video conference between the three terminals T1 520, T2 530 and T3 540 without interference from the firewalls 525, 535 and 545. Also, the persistent connections of the three terminals T1 520, T2 530 and T3 540 allow a/v data streams to be sent, received and fulfilled among the three terminals on demand in a real time manner.

The exchange of a/v data streams can be accomplished using any of a number of known methods. One example, that is used in the preferred embodiments, is proxy server 515 performs a replication process. In other words, when terminal T1 520 sends an a/v data stream to the proxy server 515, the proxy server 515 replicates the a/v data stream such that one or more copies of the a/v data stream is produced by the proxy server 515. Then, each copy of the a/v data stream is sent by the proxy server 515 to each of the other terminals participating in the video conference via the respective persistent connection of each terminal.

The video communications systems allow each terminal to receive and view one or more a/v data stream in well-known manners. For example, the systems permit each terminal participating in a video call or conference to set permissions for its a/v data stream in order to allow or not allow its a/v data stream to be accessed by other terminals. Another example is one terminal has administrative control over which a/v data stream is received and viewed by each terminal participating in a video conference.

The preferred embodiments of the inventions avoid problems previously associated with attempts to setup video communications across a firewall separating different networks. It is important that user terminals are capable of carrying out functions described above. The terminals may include a computer readable storing medium for storage of computer program instructions that are executable by a computer processor. Execution of the instructions implements the methods of the preferred embodiments of the inventions. The computer readable storing medium may be a compact disk, hard drive, DVD-ROM, CD-ROM, or any other suitably appropriate and accessible computer readable storing medium, as is well understood. Also, the terminals may be any type of computer processor based arrangement such as, for example, a personal computer, a wireless computer arrangement (e.g., Personal Digital Assistant, notebook computer, etc.) or any other suitably appropriate processor arrangement.

Each user terminal is preferably a personal computer (PC) with a SVGA display monitor capable with a display resolution of 800×600 or better, a set of attached speakers or headphones, microphone and full duplex sound card. The display monitor is preferably able to display a video signal in a large main screen at a normal resolution mode of 320×240@25 fps or a high resolution mode of 640×480@25 fps, and to simultaneously display a plurality of small sub-screens having a display resolution of 160×120@25 fps. Each PC has a camera associated therewith to provide a video signal at the location of the user terminal (typically a video signal of the user at the location). The camera may be a Universal Serial Bus (USB) 1.0 or 2.0 compatible camera providing a video signal directly to the user terminal or a professional Charge Coupled Device (CCD) camera combined with a dedicated video capture card to generate a video signal that can be received by the user terminal.

The video communication systems preferably utilize user terminals that have the processing capabilities of a high-speed Intel Pentium 4 microprocessor with 256 MB of system memory, or better. In addition, each user terminal should have Microsoft Windows or other operating system software that permit it to receive and store a computer program in such a manner that allows it to utilize a low level language associated with the microprocessor and/or other hardware elements. Such personal computers are now commonly available and are computationally powerful and able to process video conferencing data. Each one of the user terminals performs processing of its outgoing video signals and incoming video signals and other processing related to operation of the video conferencing system.

The video conferencing systems may utilize the video media stream structure, compression technique, coding and motion vector estimation of the preferred video communication embodiments of the parent applications. In particular, the bit stream is preferably optimized for transmission utilizing the TCP/IP protocol, which is one of the most common protocols for data networks, including the Internet. As mentioned in the parent applications, video conferencing systems typically avoid transmission over TCP/IP networks even though it utilizes less overhead in terms of data block headers, etc., because the transmission of packets often incur delay and the resulting latency is unacceptable in a-video conferencing system. However, the preferred embodiments of the parent applications utilize a unique technique for holding the data stream in a buffer and transmitting it over a TCP/IP network that results in video conferencing systems free from undesirable latency effects.

According to that technique, after a point-to-point connection is established between the two devices, multiple sockets are opened, which are called A, B, C, and D herein for simplicity, and correspond to an equal number of channels. As known, those channels are logical channels rather than predefined paths through the network and may experience different routing through routers and other network devices as they traverse the TCP/IP network. Due to the intermittent nature of TCP/IP channels and data flow or router throttle management on the carrier/ISP end, any one of the channels may be jammed or blocked at any time.

The data buffer is configured to avoid the above-mentioned problem by storing a number of data blocks equal to the number of channels by duplicating buffered data blocks as necessary to produce multiple copies of each of the data blocks. The data blocks are then ordered into different internal sequences according to the number of channels. If all of the channels are open, then the components are sent and received, concurrently. If some of the channels are blocked, then the components sent to the remaining open channels allow there to be no resultant prejudice to the video conferencing system. Prejudice is avoided not only because of the redundancy in using multiple channels to send the same data blocks, but also because the data blocks are ordered into different sequences.

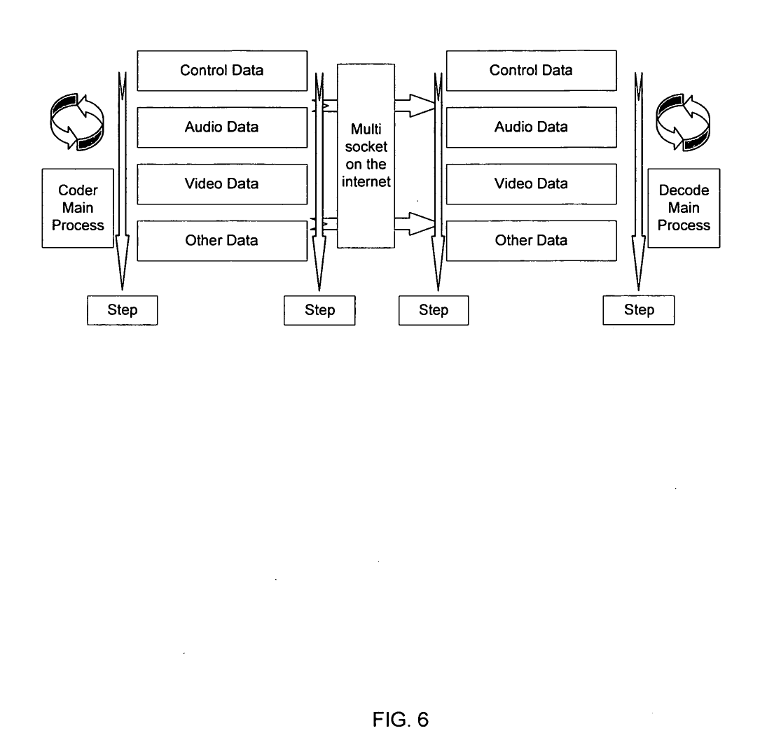

FIG. 6 illustrates a transmission architecture utilized in the preferred embodiments of the parent applications to deliver higher realized bandwidth and connection reliability over TCP/IP networks through the combination of concurrent multi-queue and multi-channel transmission architecture. As known to those of ordinary skill in the art, multiple queues are used to control the transmission of data over TCP/IP networks. Once a queue is transmitted, all other duplicated queues are deleted and a new queue is duplicated and numbered. The data blocks are preferably prioritized based on their importance to providing reayl-time video communications. From top to bottom of prioritization, there are four levels:
1^{st}—Control data (Ring, camera control . . . )
2^{nd}—Audio data
3^{rd}—Video data
4^{th}—other data (file transfer . . . )

This concurrent multi-queue and multi-channel transmission architecture delivers a much more reliable connection and smoother data flow over TCP/IP channels than was previously known. On average, the realized bandwidth is increased by 50%, which results in significant improvement in the quality of the video conferencing system.

While the invention has been described and illustrated in connection with preferred embodiments, many variations and modifications will be evident to those skilled in this art and may be made without departing from the spirit and scope of the inventions. The inventions are thus not to be limited to the precise details of methodology or construction set forth in this application as such variations and modification are intended to be included within the scope of the invention.

1. A video communications method, comprising:
establishing a persistent connection between a first terminal and a proxy server of the first terminal through a firewall between the first terminal and the proxy server;
obtaining address information for the first terminal; and
using the address information for the first terminal, establishing video communications between the first terminal and a second terminal via the proxy server, the second terminal located on the same side of the firewall as the proxy server.

2. The method in accordance with claim 1, wherein requesting the terminal address further comprises:
sending the terminal address of the first terminal from a database to the second terminal.

3. The method in accordance with claim 1, further comprising:
storing terminal registration information of the first terminal in a database.

4. The method in accordance with claim 3, wherein the terminal registration information includes terminal status information and an address of the first terminal.

5. The method in accordance with claim 1, wherein requesting the terminal address further comprises:
sending an address of the proxy server and status information of the first terminal to the second terminal.

6. The method in accordance with claim 1, wherein the persistent connection between the first terminal and the proxy server is over port 80.

7. The method in accordance with claim 1, wherein the terminal address request includes an address of the second terminal.

8. The method in accordance with claim 1, wherein at least one of the first and second terminals is connected to a TCP/IP network.

9. The method in accordance with claim 8, wherein the video conmmunications is conducted over a plurality of different channels in the TCP/IP network.

10. The method in accordance with claim 1, wherein the video communications includes transmission and reception of data streams, including audio data and video data.

11. The method in accordance with claim 1, further comprising:
sending status updates from the first terminal to a database.

12. The method in accordance with claim 1, wherein a database maintains a list of users subscribing to a video communication system administered by the database.

13. A system, comprising:
a processor; and
a computer-readable storing medium storing a set of instructions capable of being executed by the processor to implement a video communications method, and capable of performing the steps of:
establishing a persistent connection between a terminal and a proxy server of the terminal through a firewall between the terminal and the proxy server;
receiving at the proxy server a video communications message from another terminal located on the same side of the firewall as the proxy server; and
establishing video communications between the terminals via the proxy server.

14. The system in accordance with claim 13, wherein the persistent connection between the terminal and the proxy server is over port 80.

15. The system in accordance with claim 13, wherein the video conference is conducted over a plurality of different channels over a TCP/IP network.

16. The system in accordance with claim 13, wherein the video communication includes transmission and reception of data streams, including audio data and video data.

17. A computer-readable storing medium storing a set of instructions capable of being executed by a processor to implement a video communications method and capable of performing the steps of:
establishing a persistent connection between a terminal and a proxy server of the terminal through a firewall between the terminal and the proxy server;
receiving at the proxy server a video communications message from another terminal located on the same side of the firewall as the proxy server; and
establishing video communications between the terminals via the proxy server.

18. The computer-readable storing medium in accordance with claim 17, wherein the persistent connection between the terminal and the proxy server is over port 80.

19. The computer-readable storing medium in accordance with claim 17, wherein the video conference is conducted over a plurality of different channels over TCP/IP network.

20. The computer-readable storing medium in accordance with claim 17, wherein the video conference includes transmission and reception of data streams, including audio data and video data.

21. A database for a video communications method, comprising:
a processor; and
a computer-readable storing medium storing a set of instructions capable of being executed by the processor and capable of performing the steps of:
receiving registration information for a terminal, the registration information including terminal status information, terminal address information and proxy server information;
storing the registration information;
receiving a request for the registration information for the terminal; and
providing at least a portion of the registration information in response to the request.

22. A computer-readable storing medium storing a set of instructions capable of being executed by a processor and capable of performing the steps of:
receiving registration information for a terminal, the terminal registration information including terminal status information, terminal address information and proxy server information;
storing the registration information;
receiving a request for the registration information for the terminal; and
providing at least a portion of the registration information in response to the request.
